(19) United States
(12) Patent Application Publication
(10) Pub. No.: US 2026/0346825 A1
(43) Pub. Date: Nov. 5, 2026

(54) AN ELECTRONICALLY CONTROLLED PNEUMATIC PARKING BRAKE SYSTEM FOR A VEHICLE USING PULSE WIDTH MODULATION SIGNAL FOR HEATING ELECTROPNEUMATIC VALVES

(71) Applicant: Scania CV AB, Södertälje (SE)

(72) Inventors: Sandeep GUPTA, Södertälje (SE); Xavier DREUX, Stockholm (SE)

(73) Assignee: Scania CV AB, Södertälje (SE)

(21) Appl. No.: 19/487,555

(22) PCT Filed: Apr. 16, 2024
(86) PCT No.: PCT/SE2024/050361

§ 371 Date: Nov. 25, 2025

(30) Foreign Application Priority Data
Jun. 2, 2023 (SE) 2350680-1
Nov. 29, 2023 (SE) 2351363-3
Nov. 29, 2023 (SE) 2351364-1

(51) Int. Cl. B60T 13/68; B60T 17/22

(52) U.S. Cl. CPC B60T 13/683; B60T 17/221; B60T 2270/406

(57) ABSTRACT

An electronically controlled pneumatic parking brake system for a vehicle is described. The system comprises a controller, an air supply source, and two electropneumatic valves. The controller is designed to generate electronic brake signals for activating or deactivating the parking brake. The electropneumatic valves, connected to the controller and the air supply source, function by releasing or applying the brake based on the received signals. If a valve malfunction is detected, the controller controls a Pulse Width Modulation (PWM) signal generator to generate a PWM signal, which provides heating to the malfunctioning valves, aiming to restore their function by melting ice in the valves.

### CROSS-REFERENCE TO RELATED APPLICATIONS

This application is a national stage application (filed under 35 U.S.C. § 371) of PCT/SE2024/050361, filed Apr. 16, 2024, of the same title, which in turn claims priority to Swedish Patent App. No. 2350680-1, filed on Jun. 2, 2023, Swedish Patent App. No. 2351363-3, filed on Nov. 29, 2023, and Swedish Patent App. No. 2351364-1, filed on Nov. 29, 2023; the contents of each of which are hereby incorporated herein by reference.

### TECHNICAL FIELD

This document discloses heating of parts of an electronically controlled pneumatic parking brake system for a vehicle according to the appended patent claims.

### BACKGROUND

In vehicles in general, a parking brake solution is often applied when the vehicle is parked in a standstill position, for avoiding that the vehicle starts rolling during unattended parking, which may cause severe accidents. The parking brake is important for any kind of vehicles, but perhaps in particular for heavier vehicles such as trucks, busses, and vehicle combinations, as consequences of an accident will be severe.

The vehicle, in case of a manned vehicle, often comprises a hand brake system which could be driver-activated by a parking brake control in the cabin of the vehicle. When activating the parking brake control, air is evacuated from a spring brake chamber/pneumatic brake circuit, and springs acting on the brakes of the vehicle exerts a load on the brakes and thereby preventing the wheels of the vehicle from rolling.

A problem with parking brakes in general is that they may freeze in sub-zero temperatures (Celsius), and thereby either be stuck in a released position, making it impossible to apply the parking brake; or alternatively be stuck in an applied position, making it impossible to release the parking brake.

In case the brakes become frozen in applied position after parking, the vehicle transportation will be delayed, and the vehicle may have to be towed to a garage or similar location for defrosting.

A known “solution” for preventing the parking brake to freeze in the applied position is to simply not apply the parking brake at all in cold/sub-zero temperatures. Although solving the problems concerning the parking brake frozen solid, other worries may emerge in case the vehicle starts rolling while being parked, for example due to impact of another vehicle and/or influence from gravity.

It appears that further improvement is required for improving parking safety and eliminate or at least reducing problems associated with frozen parking brakes of a vehicle in cold weather conditions.

### SUMMARY

It is therefore an object to solve at least some of the above problems and provide a safe parking brake solution for a vehicle also in cold temperature below zero degrees Celsius.

According to a first aspect of the invention, this objective is achieved by an electronically controlled pneumatic parking brake system for a vehicle. The system comprises a controller configured to generate an electronic brake apply signal when receiving an indication of that a parking brake is to be onset/activated. The controller is also configured to generate an electronic brake release signal when receiving an indication of that the parking brake is to be released/deactivated.

The system also comprises an air supply source, for providing compressed air. In addition, the system comprises a first electropneumatic valve, communicatively connected to the controller and connected to the air supply source and to a control chamber. The first electropneumatic valve is operable to release the parking brake by opening the first electropneumatic valve, thereby allowing compressed air to flow through the first electropneumatic valve into the control chamber when receiving the electronic brake release signal from the controller.

The system additionally comprises a second electropneumatic valve, communicatively connected to the controller and connected to the control chamber and to an exhaust port. The electropneumatic valves may for example comprise solenoids, such as i.e., bistable solenoids, or any similar technical solution. The second electropneumatic valve is operable to activate the parking brake by opening the second electropneumatic valve thereby releasing compressed air from the control chamber to atmosphere via an exhaust port when receiving the electronic brake apply signal from the controller.

The controller is configured to detect that the first electropneumatic valve and/or the second electropneumatic valve is/are malfunctioning. Also, the controller is configured to control a Pulse Width Modulation (PWM) signal generator of the first electropneumatic valve and the second electropneumatic valve, to generate and provide a PWM signal at a duty cycle below a threshold limit, to the first electropneumatic valve and the second electropneumatic valve for heating the valves aiming to restore the function of the electropneumatic valves.

Moisture accumulated in the system may eventually get converted into ice during cold weather conditions, below zero degrees Celsius. The moving parts in the valves are particularly sensitive for being frozen. In case they are frozen, the functionality of the parking brake is endangered as the change between states of the parking brakes (released/applied) is executed via the valves.

By intentionally heating up the valves when detecting malfunction, any ice formation having built up in the valves is melted/evaporated. Reliable functionality of parking brakes also in cold climate/weather conditions is assured. Traffic safety is thereby assured.

Optionally, the controller may be configured to output information to a driver of the vehicle concerning the malfunctioning valves, upon detection of the malfunctioning valves. Also, the controller may be configured to control the PWM signal generator to generate and provide the PWM signal when having obtained a confirmation of the valve heating from the driver.

By providing information concerning the malfunctioning valves and requesting a confirmation from the driver before running the parking brake recovery program, the driver is informed about the situation and understands that the parking procedure (or brake release procedure) will be delayed, but probably solved.

Optionally, the controller may be configured to obtain an indication affirming that the driver is present in the cabin. The controller may also be configured to control the PWM signal generator to generate and provide the PWM signal when having obtained the indication affirming that the driver is present in the cabin.

By requiring that the driver is present in the cabin while performing the recovery program, accidents due to that the parking brakes suddenly releases due to ice melting in the valves while no driver is present, are prevented.

Optionally, the duty cycle of the PWM signal may be below the threshold limit of about 50%.

By keeping the duty cycle of the PWM signal low, overheating of the valves is avoided. Thereby, operative lifetime of the valves is extended. It should be noted that no additional equipment, such as e.g., temperature sensors, or any further measures are required in order to control the overheating of the valves, which is a great advantage.

Optionally, the controller may be configured to control the PWM signal generator to generate and provide the PWM signal at a duty cycle between about 20-40%.

It is desired to avoid overheating of the valves, yet minimizing the heating time for melting the ice plug in the valve/s. It has been found that keeping the duty cycle of the PWM signal between about 20-40% is a convenient compromise for the expected ambient temperatures.

Optionally, the controller may be operable to obtain information indicative of a pressure in a spring brake chamber of the parking brake, or the pressure in an entity pneumatically connected to the spring brake chamber. The detection of the malfunctioning first electropneumatic valve and/or the second electropneumatic valve may be made based on the obtained information of said pressure.

In case any of the valves is blocked by an ice plug, the pressure of the spring brake chamber of the parking brake may be different from the expected. By measuring the pressure with a pressure sensor, a reliable detection is provided in case the pressure in the spring brake chamber is different from the expected pressure as indicated by the hand control unit.

Optionally, the controller may be configured to control the PWM signal generator to generate and provide the PWM signal at the same duty cycle as during normal operation.

By providing the PWM signal at the same duty cycle as during normal operation, implementation is facilitated. A typical duty cycle may be around 33%.

Optionally, the controller may be configured to control the PWM signal generator to generate and provide the PWM signal, either until detecting that the first electropneumatic valve and/or the second electropneumatic valve is/are functioning; or until lapse of a predefined or configurable time limit; or until an indication is received that the driver is absent in the non-autonomous vehicle; or until no service brake signal is received.

In case the electropneumatic valve/s is/are not operating as expected after the time limit, there may be another reason for the malfunction besides ice formation in the valves. By terminating the recovery program after lapse of the time limit, other troubleshooting programs may be initiated.

When the first electropneumatic valve and/or the second electropneumatic valve is/are functioning, the ice formation has been melted and there is no reason to continue running the recovery program.

There are also safety reasons for interrupting the recovery program before the time limit has ended, also when the parking brake is not recovered. By interrupting the recovery program when the driver leaves the vehicle, a potential accident is avoided.

Optionally, the controller may be operable to obtain information of an ambient temperature. Also, the controller may be configured to adjust the time limit length and/or the length of the duty cycle based on the ambient temperature.

The time limit length of the recovery program and/or the length of the duty cycle is thereby optimized with regard to the temperature.

According to a second aspect of the invention, this objective is achieved by a method for a controller of a vehicle comprising an electronically controlled pneumatic parking brake system according to the first aspect.

The method comprises the step of detecting that the first electropneumatic valve and/or the second electropneumatic valve is/are malfunctioning. The method also comprises controlling a PWM signal generator of the first electropneumatic valve and the second electropneumatic valve, to generate and provide a PWM signal at a duty cycle below a threshold limit, to the first electropneumatic valve and the second electropneumatic valve for heating the valves aiming to restore the function of the electropneumatic valves.

By heating up the valves when they could be assumed to be frozen, any ice therein is melted/evaporated. Reliable functionality of parking brakes also in cold climate/weather conditions is assured. Traffic safety is thereby assured.

Optionally, the method may also comprise the step of outputting information to a driver of the vehicle concerning the malfunctioning valves, upon detection of the malfunctioning valves. Also, the method may comprise obtaining a signal from the driver, confirming that the valves are to be heated. The step of controlling the PWM signal generator to generate and provide the PWM signal may be performed when having obtained the confirmation of the valve heating from the driver.

By providing information concerning the malfunctioning valves and requesting a confirmation from the driver before running the recovery program, the driver is informed about the situation and understands that the parking procedure (or brake release procedure) will be delayed, but probably solved.

Optionally, the method may also comprise the step of obtaining an indication affirming that the driver is present in the cabin. Also, the step of controlling the PWM signal generator to generate and provide the PWM signal when having obtained the indication affirming that the driver is present in the cabin.

By requiring that the driver is present in the cabin while performing the recovery program, accidents due to the parking brakes suddenly releases due to ice melting in the valves while no driver is present, are prevented.

Optionally, the step of controlling the PWM signal generator to generate and provide the PWM signal, may comprise an instruction to generate and provide the PWM signal at a duty cycle between about 20-40%.

It is desired to avoid overheating of the valves, yet minimizing the heating time for melting the ice plug in the valve/s. It has been found that keeping the duty cycle of the PWM signal between about 20-40% is a convenient compromise for the expected ambient temperatures.

Optionally, the method also comprises the step of obtaining information indicative of a pressure in a spring brake chamber of the parking brake, or the pressure in an entity pneumatically connected to the spring brake chamber.

In case any of the valves is blocked by an ice plug, the pressure of the spring brake chamber of the parking brake may be different from the expected. By measuring the pressure with a pressure sensor, a reliable detection is provided in case the pressure in the spring brake chamber is different from the expected pressure as indicated by the hand control unit.

Optionally, the step of detecting that the first electropneumatic valve and/or the second electropneumatic valve is/are malfunctioning may be made based on the obtained information.

In case the electropneumatic valve/s is/are not operating as expected after the time limit, there may be another reason for the malfunction besides ice formation in the valves. By terminating the recovery program after lapse of the time limit, other troubleshooting programs may be initiated.

Optionally, the step of controlling the PWM signal generator to generate and provide the PWM signal, may comprise an instruction to generate and provide the PWM signal at the same duty cycle as during normal operation.

By providing the PWM signal at the same duty cycle as during normal operation, implementation is facilitated. A typical duty cycle may be around 33%.

Optionally, the step of controlling the PWM signal generator may comprise an instruction to interrupt generating and providing the PWM signal either when detecting that the first electropneumatic valve and/or the second electropneumatic valve is/are functioning; or upon lapse of a predefined or configurable time limit; or when an indication is received that the driver is absent in the non-autonomous vehicle; or when no service brake signal is received.

In case the electropneumatic valve/s is/are not operating as expected after the time limit, there may be another reason for the malfunction besides ice formation in the valves. By terminating the recovery program after lapse of the time limit, other troubleshooting programs may be initiated.

When the first electropneumatic valve and/or the second electropneumatic valve is/are functioning, the ice formation has been melted and there is no reason to continue running the recovery program.

There are also safety reasons for interrupting the recovery program before the time limit has ended, also when the parking brake is not recovered. By interrupting the recovery program when the driver leaves the vehicle, a potential accident is avoided.

Optionally, the method may also comprise the step of adjusting the time limit length based on ambient temperature.

The time limit length of the recovery program is thereby optimized with regard to the temperature.

According to another aspect of the invention, this objective is achieved by a computer program product comprising instructions which, when the program is executed by a computer, cause the computer to carry out the steps of the method according to the second aspect.

According to another aspect of the invention, this objective is achieved by a computer-read-able storage medium comprising instructions which, when executed by a computer, cause the computer to carry out the steps of the method according to the method according to the second aspect.

According to yet another aspect of the invention, this objective is achieved by a vehicle comprising an electronically controlled pneumatic parking brake system according to the first aspect.

Other advantages and additional novel features will become apparent from the subsequent detailed description.

### FIGURES

Embodiments of the invention will now be described in further detail with reference to the accompanying figures, in which:

FIG. 1 illustrates an embodiment of a vehicle, comprising an electronically controlled pneumatic parking brake system.

FIG. 2A illustrates a pneumatic parking brake arrangement for a vehicle, according to an embodiment, in a first state.

FIG. 2B illustrates a pneumatic parking brake arrangement for a vehicle, according to an embodiment, in a second state.

FIG. 3A illustrates an electronically controlled pneumatic parking brake system in an embodiment wherein the parking brakes are implemented as disc brakes, in a first state.

FIG. 3B illustrates an electronically controlled pneumatic parking brake system in an embodiment wherein the parking brakes are implemented as disc brakes, in a second state.

FIG. 4A illustrates a vehicle interior of a vehicle comprising an electronically controlled pneumatic parking brake system.

FIG. 4B illustrates a vehicle interior of a vehicle comprising an electronically controlled pneumatic parking brake system.

FIG. 4C illustrates a vehicle interior of a vehicle comprising an electronically controlled pneumatic parking brake system.

FIG. 4D illustrates a vehicle interior of a vehicle comprising an electronically controlled pneumatic parking brake system.

FIG. 4E illustrates a vehicle interior of a vehicle comprising an electronically controlled pneumatic parking brake system.

FIG. 4F illustrates a vehicle interior of a vehicle comprising an electronically controlled pneumatic parking brake system.

FIG. 4G illustrates a vehicle interior of a vehicle comprising an electronically controlled pneumatic parking brake system.

FIG. 4H illustrates a vehicle interior of a vehicle comprising an electronically controlled pneumatic parking brake system.

FIG. 5 illustrates a method for a controller of a vehicle comprising an electronically controlled pneumatic parking brake system, in an embodiment.

### DETAILED DESCRIPTION

Embodiments of the invention described herein are defined as an electronically controlled pneumatic parking brake system and a method, which may be put into practice in the embodiments described below. These embodiments may, however, be exemplified and realized in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein. Like numbers refer to like elements throughout.

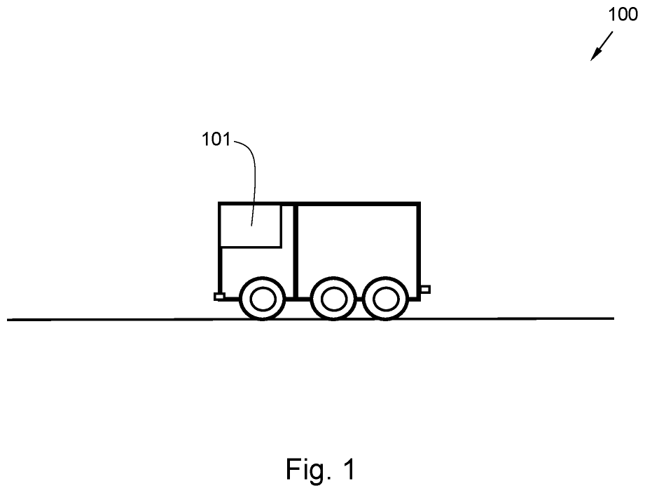

FIG. 1 illustrates a vehicle 100 comprising an electronically controlled pneumatic parking brake system.

The vehicle 100 could for example be or comprise a truck, a car, a trailer, a bus, an articulated vehicle (comprising a tractor and a trailer/semi-trailer) or other similar manned or unmanned (i.e., autonomously controlled) means of conveyance on a driving surface. However, for enhanced clarity, the vehicle 100 is subsequently described as having a driver.

The vehicle 100 may comprise a cabin 101, in which a driver normally is situated during operation of the vehicle 100. In some alternative embodiments, wherein the vehicle 100 may be driverless, i.e., autonomously controlled, the vehicle 100 may not comprise any cabin.

The vehicle 100 also comprises a propulsion unit such as an internal combustion engine, an electrical engine, or a combination thereof.

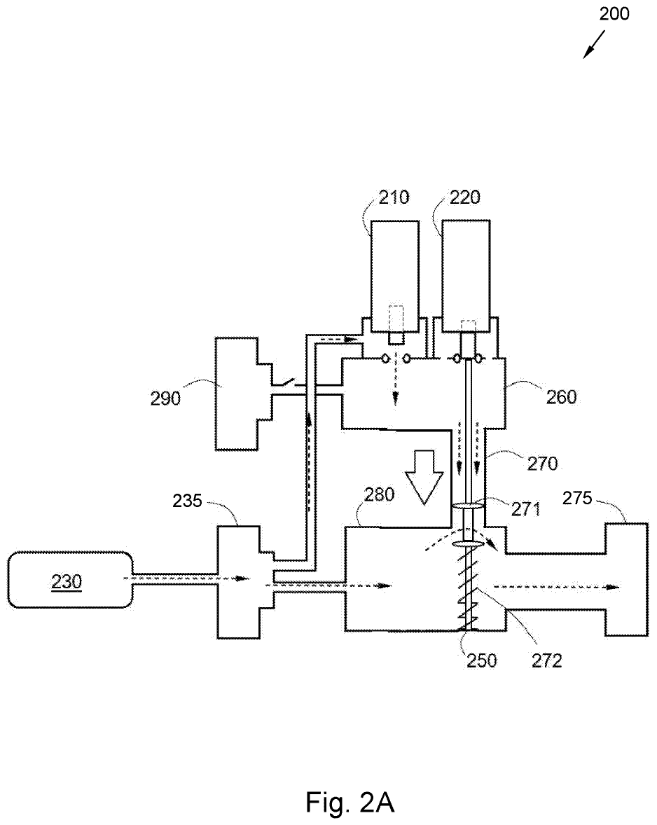

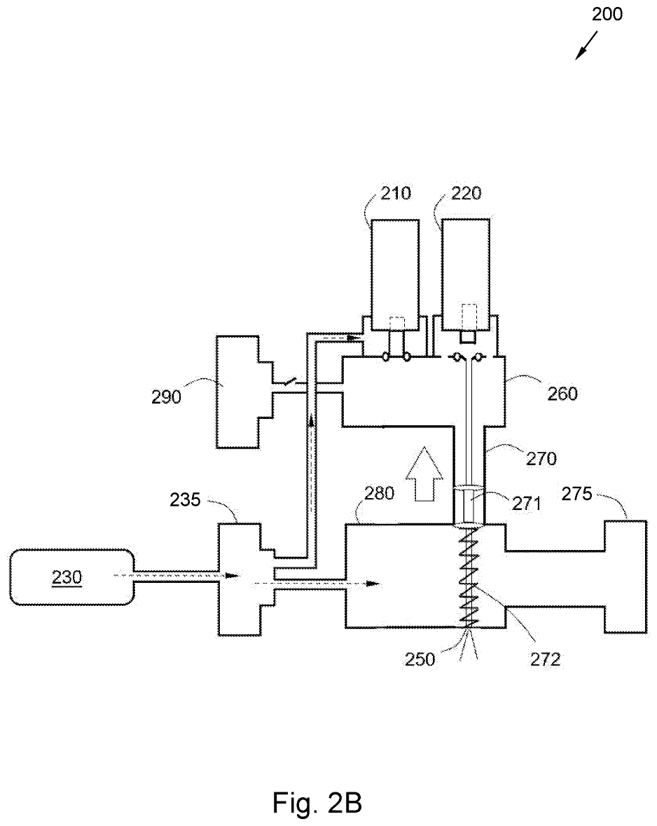

FIGS. 2A-2B schematically illustrate a pneumatic parking brake arrangement 200 of the vehicle 100 of FIG. 1.

The parking brake arrangement 200 is a mechanism to ascertain that the vehicle 100 is maintained motionless when parked, also when the vehicle 100 has been parked for example in a slope or other uneven underneath, where gravity or impact by another vehicle otherwise may bring the vehicle 100 into undesired movements, by immobilizing wheels of the vehicle 100. The parking brake functionality is sometimes also referred to as a hand brake (to distinguish it from the mechanically independent service brake, or footbrake as it also may be referred to, which is commonly used during propulsion of the vehicle 100). The vehicle 100 may comprise additional service brakes, auxiliary brakes such as retarder, or similar system for decreasing vehicle speed during propulsion.

The pneumatic parking brake arrangement 200 may comprise various components, such as an air supply source connection 235, for providing compressed air.

The pneumatic parking brake arrangement 200 comprises brake chamber connection 375, connected to a spring brake chamber associated with a parking brake.

The parking brake is released when pressurized air is provided to the spring brake chamber, and applied when the pressurized air is evacuated from the spring brake chamber.

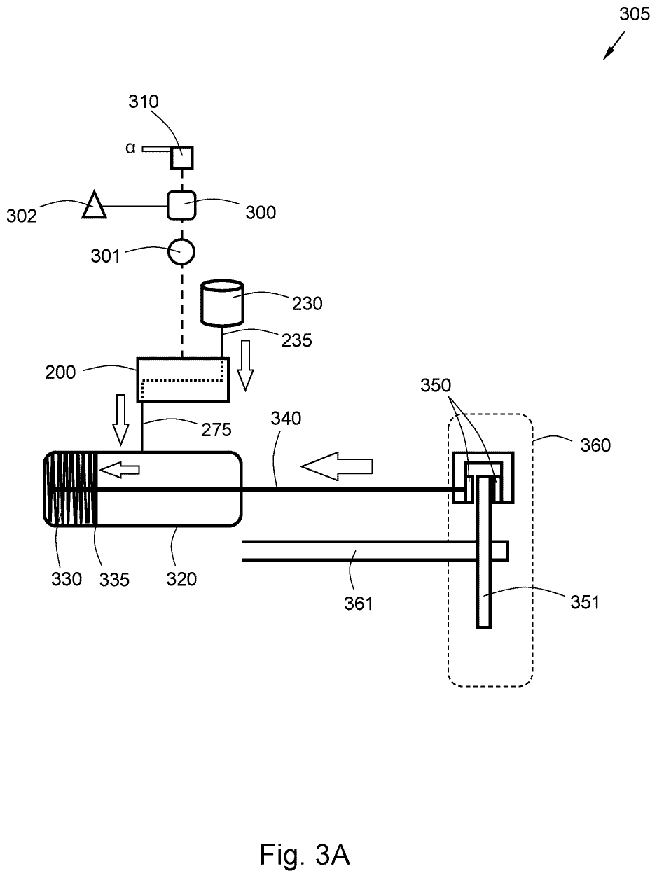

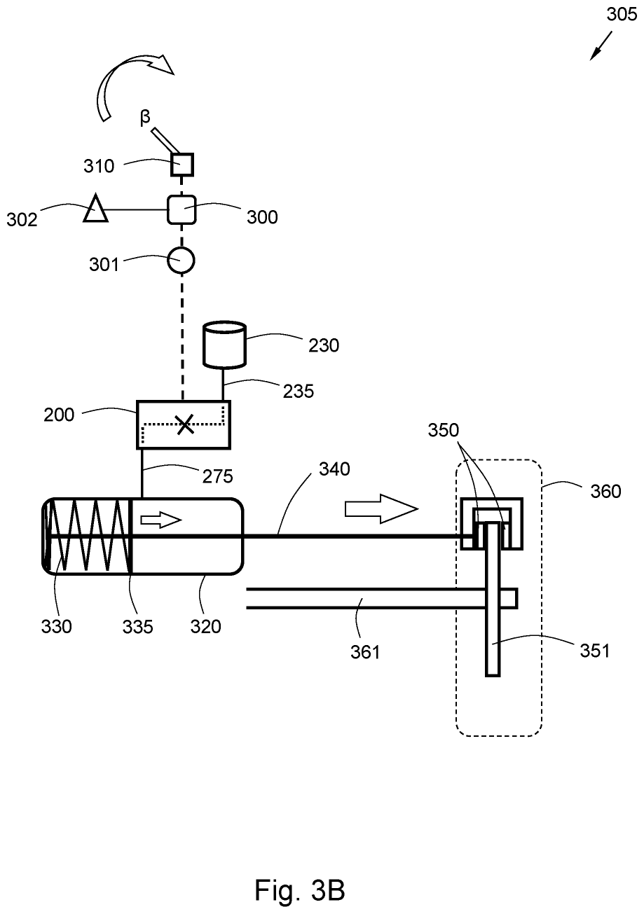

The details of the functionalities of the parking brake and the spring brake chamber are illustrated and described more in detail in FIGS. 3A-3B and corresponding section of the description.

In a typical scenario, the vehicle 100 may comprise one parking brake per wheel set of the vehicle 100. However, in alternative embodiments only some or one wheel set of the vehicle 100 may comprise a parking brake.

In case the vehicle 100 comprises an articulated vehicle, brakes on all or at least some or one of the brakes of the trailer/semi-trailer may comprise a respective spring brake chamber.

The supply of pressurized air to the spring brake chamber of the parking brake from the air supply source is controlled by a controller, via a first electropneumatic valve 210, and a second electropneumatic valve 220. The electropneumatic valves 210, 220 may comprise a solenoid or other similar means for setting the respective valve 210, 220 in positions for allowing/disallowing passage of pressurized air by opening/closing the respective electropneumatic valve 210, 220. In other embodiments, additional electropneumatic valves may be comprised, for example for the purpose of emergency braking, or when the vehicle 100 forms part of an articulated vehicle, wherein the additional electropneumatic valves may be dedicated for parking brakes of the trailer/semi-trailer.

The controller may comprise e.g., one or several Electronic Control Units (ECUs), typically a plurality of interacting ECUs. The controller may comprise a digital computer that controls one or more electrical systems, or electrical sub systems, of the vehicle 100, based on e.g., information read from the sensors placed at various parts and in different components of the vehicle 100, and/or signals generated by the driver, or an autonomous driving system. The controller is configured to evaluate the obtained sensor detection readings/signals, e.g., compare it/them with a respective threshold limit and generate control signals, based on the outcome of the comparison.

Computer in the current context may be regarded as any hardware or hardware/ firmware device implemented using processing circuity such as, but not limited to, a processor, Central Processing Unit (CPU), a controller, an Arithmetic Logic Unit (ALU), a digital signal processor, a microcomputer, a Field Programmable Gate Array (FPGA), a System-on-Chip (SoC), a programmable logic unit, a microprocessor, an application-specific integrated circuit, or any other device capable of electronically performing operations in a defined manner.

The first electropneumatic valve 210 and the second electropneumatic valve 220 are both communicatively connected to the controller via a wired or wireless communication interface.

Various entities on-board the vehicle 100, such as for example the controller and the electropneumatic valves 210, 220 may communicate and/or exchange information over a data-link, e.g., via a bus such as e.g., a Controller Area Network (CAN) bus, a Media Oriented Systems Transport (MOST) bus, or similar.

Communication may alternatively be made over a wireless communication interface, such as e.g., Vehicle-to-Vehicle (V2V) communication, or Vehicle-to-Infrastructure (V21) communication. The common term Vehicle-to-Everything (V2X) is sometimes used. The wireless communication may then be based on Dedicated Short-Range Communications (DSRC) devices. DSRC works in 5.9 GHz band with bandwidth of 75 MHz.

The first electropneumatic valve 210 is connected to the air supply source 230 and to a control chamber 260. The first electropneumatic valve 210 is operable to release the parking brake by opening the valve 210, thereby allowing compressed air to flow through the first electropneumatic valve 210 into the control chamber 260 when receiving an electronic brake release signal from the controller.

The pressure that builds up in the control chamber 260 by the compressed air acts on a control piston 271 and overcomes the pressure of a spring 272 in a working chamber 270, such that pressurized air is allowed to flow via a supply chamber 280 and the brake chamber connection 275 to the brake chamber.

Thereby, the parking brake is released and the vehicle 100 is ready for take-off.

The pneumatic parking brake arrangement 200 may also comprise a control port 290, through which pressurized air may be supplied to the control chamber 260 in a case of emergency when ice is blocking the first electropneumatic valve 210, or the first electropneumatic valve 210 is net working for some other reason.

In the opposite case, when switching from driving to parking is desired, the second electropneumatic valve 220 is opened, when receiving a control signal from the controller.

The second electropneumatic valve 220 is connected to the control chamber 260 and to an exhaust port 250, through which pressurized air from the control chamber 260 is releasable to atmosphere. The second electropneumatic valve 220 is operable to activate the parking brake by opening the valve 220 thereby releasing the compressed air from the control chamber 260 to atmosphere via the second electropneumatic valve 220 when receiving the electronic brake apply signal from the controller, as illustrated in FIG. 2B. When the compressed air is released from the control chamber 260, the working chamber spring 270 closes the supply of compressed air from the supply chamber 280 to the outlet/spring chamber connection 275 and instead opens the spring brake chamber connection 275 to atmosphere, via the exhaust port 250.

Pressurized air in the spring brake chamber of the parking brake is thereby allowed to be released through the exhaust port 250 to atmosphere. When there is atmospheric pressure in the spring brake chamber, the parking brake will be applied.

FIGS. 3A-3B schematically illustrate an electronically controlled pneumatic parking brake system 305, comprising various components interacting with the pneumatic parking brake arrangement 200, such as for example a hand control unit 310, a spring brake chamber 320, and a parking brake 360 comprising friction pads 350 in a caliper, operative to act on a disc 351, which is fixedly mounted on a wheel axle 361.

The vehicle 100 may have the same type of brakes on all axles/wheels, for example disc brakes on all axles/wheels; or alternatively drum brakes on all axles/wheels.

The vehicle 100 may have one type of brakes on the front axle/wheels and another type of brakes on rear axles/s wheels; for example, disc brakes on the front axle/wheels while drum brakes may be applied on rear axles/s wheels.

In the schematic illustration in FIG. 3A-B, the parking brake 360 is represented by a disc brake.

The electronically controlled pneumatic parking brake system 305 may comprise a hand control unit 310, in some embodiments wherein the vehicle 100 is driven by a human driver. The hand control unit 310 may be physically situated in the cabin 101 of the vehicle 100 at some appropriate position where the driver is able to reach it without excessive ergonomical inconvenience, preferably while seated in the driving seat. In case of using the electronically controlled pneumatic parking brake system 305 as an emergency brake in an emergency situation, it may be important to enable the driver to easily find and pull/operate the hand control unit 310.

The hand control unit 310 may comprise a manually operable actuating element for actuating the parking brake 360. According to examples, the hand control unit 310 may comprise e.g., a button, a lever, a handle or other similar device.

The hand control unit 310 may comprise a hand lever which may be positioned/set in an inactive position a while driving the vehicle 100, i.e., the parking brake is released allowing the wheels of the vehicle 100 to roll. This is illustrated in FIG. 3A.

The hand control unit 310 may alternatively be set in an active position p when it is desired to park the vehicle 100. The parking brake 360 of the vehicle 100 is activated, immobilizing vehicle wheels.

FIG. 3A illustrates a situation wherein the vehicle 100 is driving, and the parking brake 360 is released. In case the vehicle 100 comprises a driver and a hand control unit 310, the hand control unit 310 is then set in the inactive position a.

An electronic brake release signal may then be provided to the controller 300. The controller 300 may in turn generate a control signal to a Pulse Width Modulation (PWM) signal generator 301 to generate and provide a PWM signal to be provided to the first electropneumatic valve 210, for opening the valve 210.

PWM is a technique used for providing a pulsing signal. The PWM signal is essentially a square wave, i.e., a signal that switches between on and off. What makes a PWM signal unique is how long the signal stays on or off. This is referred to as the duty cycle of the signal.

The first electropneumatic valve 210 is then at least temporarily opened, thereby allowing compressed air of the air supply source 230, provided via an air supply source connection 235 and the outlet/spring chamber connection 275 to the spring brake chamber 320.

Pressurized air is allowed to enter/fill the spring brake chamber 320, which is exercising a pressure on a spring 330 via an airtight seal/diaphragm 335 in the spring brake chamber 320. The pressurized air in the spring brake chamber 320 is thereby overcoming the spring force of the spring 330, as long as pressurized air is maintained in/provided to the spring brake chamber 320.

A physical connection linkage 340 between the spring 330 and at least one of the friction pads 350 is thereby pulled away from the disc 351, disengaging the brake 360, thereby allowing the wheel/wheel axle 361 to rotate freely without obstruction.

The controller 300 is configured to adjust the duty cycle, thereby controlling how much power is being delivered to the electropneumatic valves 210, 220. A higher duty cycle means more power because the signal is on more of the time. A lower duty cycle means less power.

The PWM signal generator 301 operates by switching between full power transfer and no power transfer. The PWM signal generator 301 thus output either 1 or 0, according to a duty cycle. The duty cycle is the amount of time the signal stays in the “on” state during each cycle. This may be expressed in terms of a percentage. For example, a 50% duty cycle means the signal is on for half the time and off for the other half. If the duty cycle is 30%, the signal is on 30% of the time, and off 70% of the time. When a pulse frequency is high enough, no power interruptions are experienced at all and the electropneumatic valves 210, 220 will continue to run normally while using less electricity in comparison with a constant voltage supply.

The PWM signal generator 301, upon receiving the control signal from the controller 300, is configured to generate the signal according to the duty cycle, in a pulse train. This is performed by switching a voltage (or current) on and off at a determined frequency, according to the duty cycle. When the signal is “on”, it is at a maximum value (e.g., +5 or +10), and when it is “off”, it is at a minimum value (e.g., zero, −5 or −10).

Thanks to the PWM signal generator 301 and the PWM signal provided to the electropneumatic valves 210, 220, a precise control is obtained concerning how much power is delivered to the electropneumatic valves 210, 220.

By providing an optimal PWM signal for example at about 33% duty cycle at the determined frequency, energy consumption may be minimized, overheating of the electropneumatic valves 210, 220 is avoided, and lifespan of the involved components is extended.

FIG. 3B illustrates the electronically controlled pneumatic parking brake system 305 comprising the same components as previously illustrated in FIG. 3A. However, in this scenario, the parking brake 360 is engaged.

Thus, the hand control unit 310 is set into the active position p. The passage of pressurized air from the pressurized air supply source 230 is discontinued, as the second electropneumatic valve 220 is at least temporarily opened which allows the pressurized air maintained in the spring brake chamber 320 to be evacuated to atmosphere.

When no pressurized air is maintained in the spring brake chamber 320, the spring force of the spring 330 is causing a pressing action on the friction pads 350 towards the disc 351 of the disc brake 360 thereby disallowing rotational movement of the wheel/axle 261.

Thereby, thanks to the functionality of the spring brake chamber/s 320, the parking brake 360 automatically becomes activated and engaged when there is an air supply leakage or other anomaly in the air pressure, and/or when the pressurized air supply source 230 has run out of pressurized air. A compressor may then be activated to refill the pressurized air supply source 230 with pressurized air, before the parking brakes 360 could be released.

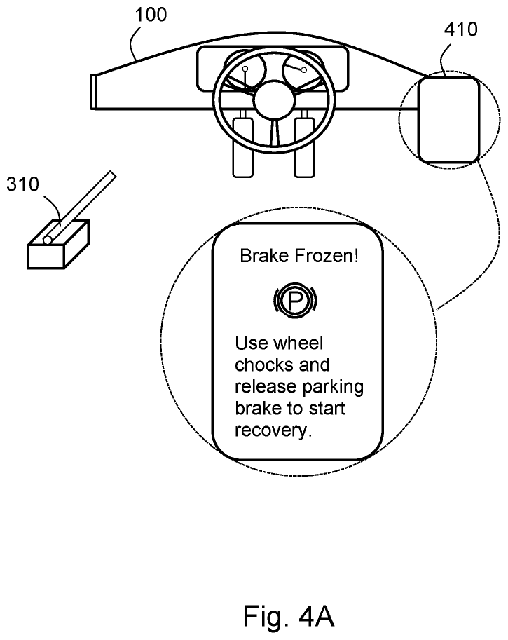

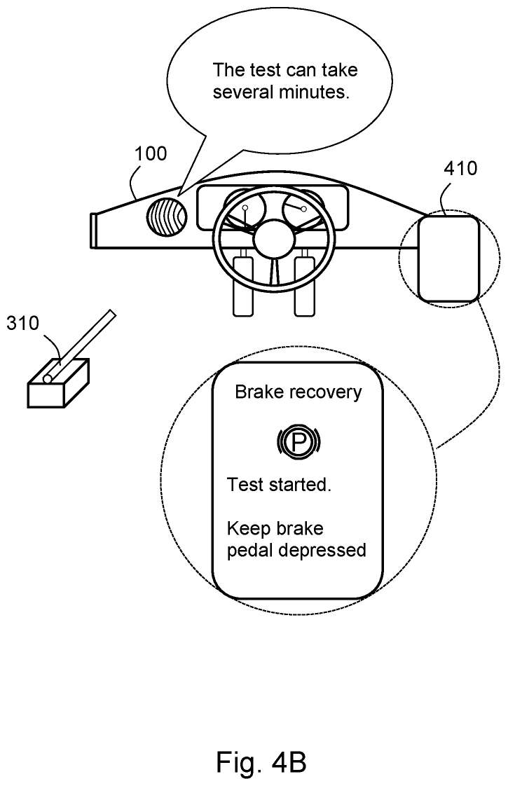

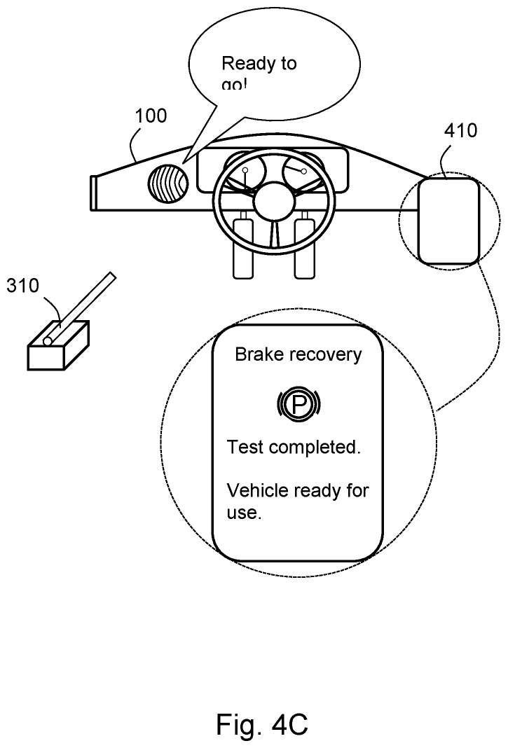

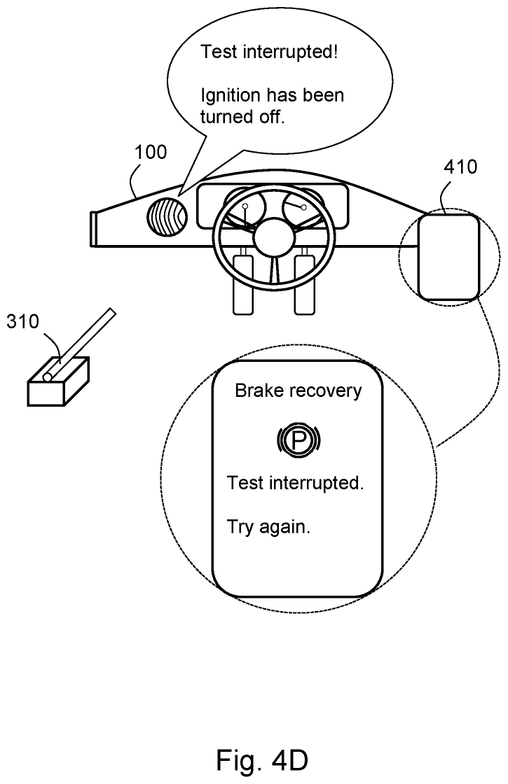

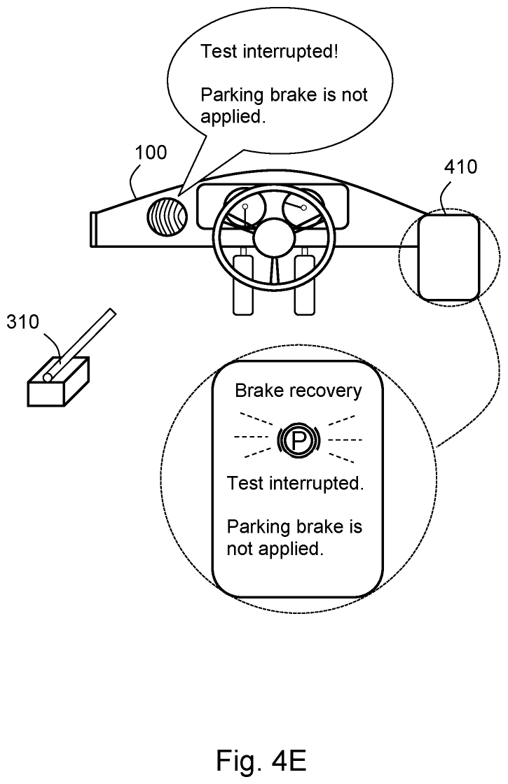

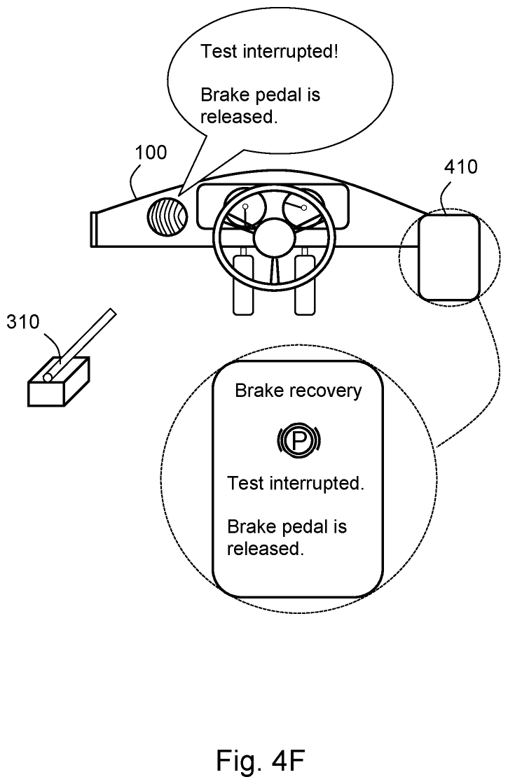

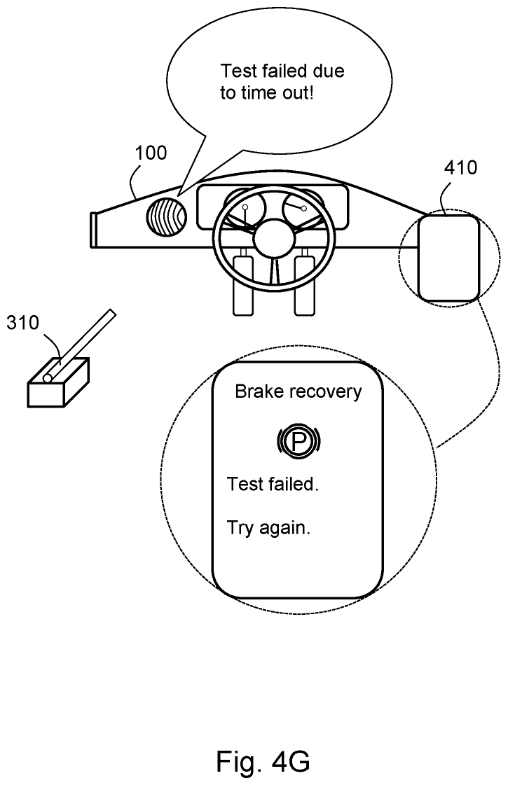

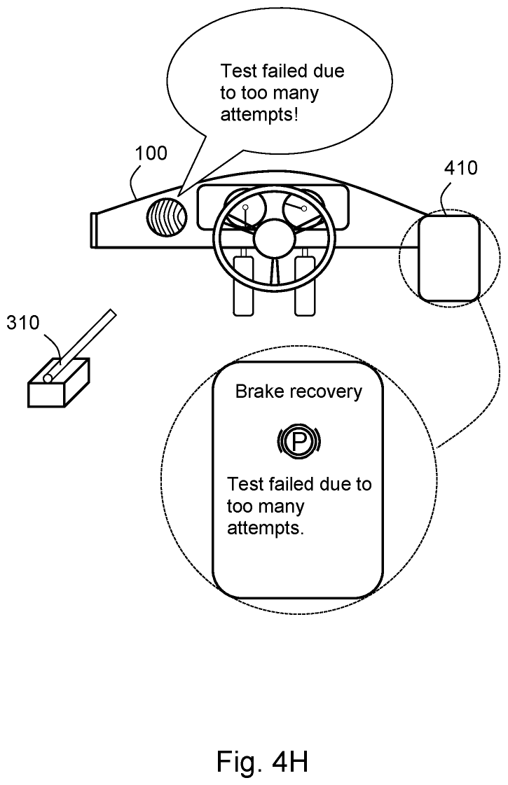

FIGS. 4A-4H schematically illustrate a vehicle interior of a vehicle 100 comprising an electronically controlled pneumatic parking brake system 305, such as for example the vehicle 100 illustrated in FIG. 1.

The provided solution comprises detecting that the first electropneumatic valve 210 and/ or the second electropneumatic valve 220, or alternatively the parking brake is not working. An assumption may be made that the reason for the malfunctioning is ice formation in the electropneumatic valves 210, 220, for example based on temperature estimation.

In a scenario wherein the vehicle 100 has been parked outside in low temperature, the driver may enter the vehicle 100 and ignite the engine. In case it is detected that the first electropneumatic valve 210 and/or the second electropneumatic valve 220 is/are malfunctioning, it may be concluded that the reason is that they are frozen. Low temperature in this context may be below 0 degrees, or there about.

A pre-heating function may then be triggered, in order to achieve a successful engagement of the parking brake, after having been able to release the parking brake after subsequently performed recovery function. Also, the time is reduced, for which the driver/ vehicle 100 would have to spend in immobility before being able to take-off.

A conclusion may be made, that the driver when turning on the ignition desires to start driving the vehicle 100 within shortly. This is however not always the case; the driver may turn on the ignition to for example access the vehicle navigator or entertainment module; to make a safety test (checking headlights functionality for example), and then switch off the ignition and leave the vehicle 100 for a coffee break, or other arbitrary reason. The pre-heating function may then be terminated or paused when the ignition is switched off until the ignition is switched on the next time.

The pre-heating function comprises generating and providing a PWM signal at an operative duty cycle to the second electropneumatic valve 220 for heating the second electropneumatic valve 220, aiming to restore the function of the second electropneumatic valve 220 by heating and thereby melting ice formation at the second electropneumatic valve 220.

The applied operative duty cycle is appropriate for actuating the electropneumatic valves 210, 220, i.e., the same duty cycle that normally is used for actuating the electropneumatic valves 210, 220. The operative duty cycle may be set to a value within an interval 20%-40%, such as for example about 33%.

Information concerning the detected frozen parking brake may be output to the driver on an output device 410 in the cabin 101, as illustrated in FIG. 4A. The driver is informed about the frozen brake conditions and encouraged to initiate a recovery function by using wheel chocks and releasing the parking brake.

The recovery function comprises heating the first electropneumatic valve 210 and the second electropneumatic valve 220. The heating may be made for example by activation of an electric heater, or other arbitrary thermal energy providing structure.

The electric heater may be arranged at or in close vicinity of the electropneumatic valves 210, 220. The electric heater is designed to provide thermal energy to the valves 210, 220, to prevent or mitigate condensation, and/or freezing. These issues are particularly prevalent in environments with low temperatures and/or high humidity and can impair the functionality of the valves 210, 220 or lead to operational failures.

The electric heater may comprise or be made of resistive materials like nichrome (nickelchromium), or similar. When electrical current flows through this element, it heats up due to electrical resistance. By arranging the electric heater close to or integrated into the valves 210, 220, typically around areas therein prone to freezing.

The heater may be powered electrically, either from an external power source or from the control system of the valves 210, 220.

The inclusion of an electric heater in the electropneumatic valves 210, 220 enhances reliability and efficiency of the parking brakes 360, especially in challenging environmental conditions.

The heating according to the recovery function may alternatively be performed by running the PWM signal generator 301, to generate and provide the PWM signal at the operative duty cycle, also to the first electropneumatic valve 210, for heating the first electropneumatic valve 210 in addition to the already commenced heating, of the pre-heating function, of the second electropneumatic valve 220, aiming to restore the function of both the first electropneumatic valve 210 and the second electropneumatic valve 220. The applied operative duty cycle during recovery may be the same as applied during the pre-heating function, i.e., the operative duty cycle may be set to a value within an interval 20%-40%, or about 33%.

The PWM signal generator 301 may in some embodiments be instructed to adapt the operative duty cycle of the PWM signal, based on the ambient temperature, wherein an active phase of the operative duty cycle is extended in lower ambient temperature and vice versa.

For example, when the ambient temperature is lower than −20 degrees, the operative duty cycle may be set to 40%; when the ambient temperature is about −20-−10 degrees, the operative duty cycle may be set to 30%; when the ambient temperature is about −10-0 degrees, the operative duty cycle may be set to 20%; etc.

When receiving at least an implicit signal that the driver desires to run the recovery function, the recovery function may start and information similar to what is communicated in FIG. 4B may be output. The wording “test” may be interpreted as, or exchanged for: “brake recovery program”, “brake defrosting program” or similar expression.

For safety reasons, it may be required that the driver is present in the cabin 101 and for example keep the service brake pedal depressed, during the heating of the electropneumatic valves 210, 220. It is thereby avoided that the vehicle 100 (unintentionally) starts rolling in case the driver should run the recovery program and the parking brake suddenly is released as the ice of the electropneumatic valves 210, 220 melt.

The recovery program may comprise generating and providing a PWM signal in a duty cycle of about 20%-50% or so, such as for example about 33%, for a time limit. The applied duty cycle of the PWM signal may be the same duty cycle as is applied during normal operation for opening the electropneumatic valves 210, 220, in some embodiments.

The time limit for applying the recovery program may be for example 10-60 seconds, or 1-5 minutes, for example. In an embodiment, the recovery program may last for about 1 minute, during which the PWM signal in the determined duty cycle is provided to the electropneumatic valves 210, 220. The recovery program may then be interrupted when the electropneumatic valves 210, 220 starts operating, or alternatively when the time limit is reached. In the latter case, the driver may be asked to repeat the recovery program.

There may also be other conditions for interrupting the recovery program in some embodiments. One such reason may be that the driver releases the service brake pedal, opens the door and/or leaves the vehicle 100. The interruption may then be made for safety reasons, as it may be dangerous in case the parking brake 360 is released while no driver is present in the cabin 101. A message similar to the one illustrated in FIG. 4F may be output, informing the driver concerning the interruption of the recovery function.

Another reason for interrupting the recovery function may be that the driver changes plans and switches off the ignition and leave for another coffee break. A message similar to the illustration of FIG. 4D may be output to the driver, informing him/her that the recovery function is interrupted.

The recovery function may also be interrupted when the driver releases the parking brake, for safety reasons. Information similar to what is illustrated in FIG. 4E may be output.

The recovery function may alternatively be interrupted when reaching a time out limit, see FIG. 4G, and/or too many repeated attempts, see FIG. 4H. In case the functionality of the electropneumatic valves 210, 220 has not been recovered within the time out limit, it may be concluded that there may be some other problem with the parking brake and the vehicle 100 may require professional assistance by a mechanic.

Another reason for interrupting the recovery program may be that the driver changes plans, by releasing the parking brake and starts driving. For example, in case he/she cannot engage the parking brake 360 due to ice formation, a decision may be made to let the parking brake remain in the released position (in which it is frozen) and continue the journey to warmed-up garage for parking there, and also repeat the recovery program there.

In some embodiments, the time limit length of the recovery program may be adjusted based on ambient temperature. The colder it is, the more heating energy is required to melt the ice. As the amount of heat produced by providing the PWM signal to the electropneumatic valves 210, 220, due to Joule's law:
Q=I²RT, WHERE
Q=Heat (Joules)
1=Current (A)
R=Resistance of the coil of the electropneumatic valves (ohm)
T=time (sec).

The amount of generated heat is proportional to the length of the time that the PWM signal is provided to the coil of the electropneumatic valves 210, 220. Thus, the recovery program may be allowed to run for longer time the colder it is. Some examples may be to set the time limit length of the recovery program to one minute when the ambient temperature is about/below zero degrees; 90 seconds when the ambient temperature is about/below −5 degrees; 2 minutes when the ambient temperature is about/below −10 degrees, etc.

The vehicle 100 may optionally comprise a temperature sensor, for example dedicated for determining an environmental temperature. The temperature sensor may be communicatively connected to the controller 300, which in turn may adjust the time limit length of the recovery program.

Alternatively, information on an ambient temperature may be obtained from a vehicle external source, for example a temperature sensor or weather service situated at the roadside or in another location. Such information could be obtained by the vehicle via a wireless communication interface.

The temperature may alternatively or in addition be estimated based on a combination of knowledge of geographical position of the vehicle 100, planned driving route/destination/driving direction of the vehicle 100, and knowledge of date/time and statistical data related to expected temperatures related to the date/time at the (current or future) geographical position of the vehicle 100.

The geographical position may be obtained from the navigator/GPS unit onboard the vehicle, from a cell phone of the driver, by capturing images with an onboard vehicle camera and analyze road signs with a dedicated software for image recognition/computer vision in the controller, for example. The historical/statistical temperature at the geographical position of the vehicle 100 at the concurrent time/season as recorded in a database may be utilized for temperature estimation.

In yet some embodiments, knowledge of date/time in combination with current or future geographical position of the vehicle 100 and meteorological forecast data relevant for the geographical position in combination with date/time may be relied upon.

The temperature may alternatively be estimated based on images captured by an onboard image sensor in combination with an image recognition software. In case snow or ice formations is/are detected on the image; humans are wearing winter cloths; steam comes out of exhaling humans; and/or frost is detected on the own vehicle, other vehicles, other structures, etc., it may be concluded that there is a risk of freezing.

In yet other embodiments, the temperature may be estimated based on a heating action made by the driver, for example activating of defroster, block heater, cabin heater, seat heater, etc., as the heating action typically may indicate cold/freezing temperatures.

When the function of the electropneumatic valves 210, 220 are restored due to the recovery function, an iterated series of applying and releasing the parking brake 360 is commenced in a moisture removal function. The purpose is to remove water, i.e., molten ice that has been melted during the recovery function. When the parking brake 360 is released, the first electropneumatic valve 210 is opened, and when the parking brake 360 is applied, the second electropneumatic valve 220 is opened. This continuously iterated activation of the first electropneumatic valve 210 and the second electropneumatic valve 220 will improve the air flow through the pneumatic parking brake arrangement 200, which in turn will remove water/molten ice accumulated near the respective electropneumatic valve 210, 220, out to atmosphere.

Thereby, the risk of re-freezing of the electropneumatic valves 210, 220, after a time period in freezing ambient temperature is eliminated, or at least reduced.

Information concerning the ongoing recovery program may be output to the driver also during the moisture removal i.e., the iterated series of applying and releasing the parking brake 360.

The iterated series of applying and releasing of the parking brake of the moisture removal function may be running for a limited time period (such as for example some few seconds or minutes), and/or for a limited number of iterations (such as for example in between 10-50); non-limiting examples.

In case the recovery function is successful, and the moisture removal function has been performed, a message similar to the one depicted in FIG. 4C may be output for informing the driver that the vehicle 100 is ready to go.

The driver, or the corresponding autonomous software, is then enabled to start driving the vehicle 100 towards the intended destination. However, humidity/moisture may aggregate within the pneumatic parking brake arrangement 200 during the transportation. In case the vehicle 100 is driving in freezing climate conditions, there may emerge a risk of re-freezing of the electropneumatic valves 210, 220.

Thus, in some embodiments, activation may be made, upon detection of risk of freezing of water at the electropneumatic valves 210, 220 of the vehicle 100 of a continuous-heating function. The continuous-heating function may comprise detecting a risk of re-freezing of water at/in/near the electropneumatic valves 210, 220 may freeze into solid state and block the passage of pressurized air, or otherwise hamper the functionality of the electropneumatic valves 210, 220.

This state is critical for the functionality of the parking brake 360. In a scenario, the risk of freezing of water at the electropneumatic valves 210, 220 may be concluded when the recovery function, the moisture removal function and/or the pre-heating function has/have been performed, there may remain a risk of the electropneumatic valves 210, 220 returns into a freezing state after the moisture removal function has been terminated (finished or interrupted), as water melted during the recovery function may re-freeze when the vehicle 100 is running in cold climate conditions.

The continuous-heating function may be triggered by measurement or estimation of ambient temperature, in comparison to a temperature threshold limit. The temperature threshold limit may be set to about 0 degrees Celsius in some embodiments. Alternatively, some degrees of margin may be applied, for example 1-5 degrees above 0 degrees Celsius.

When the risk detection has been made (based on the ambient temperature measurements), the PWM signal generator 301 of the first electro-pneumatic valve 210 and the second electropneumatic valve 220 may be controlled by the controller 300, to generate and provide a PWM signal at a reduced duty cycle to the first electropneumatic valve 210 and the second electropneumatic valve 220 for heating the valves 210, 220. The reduced duty cycle is lower than required to actuate the electropneumatic valves 210, 220, i.e., without actuating the electropneumatic valves 210, 220.

The reduced duty cycle may be set to a value lower than required to actuate the electropneumatic valves 210, 220, such as for example about 10-15%. The electropneumatic valves 210, 220 are thereby heated without performance of any movement of the valves 210, 220. By increasing the temperature at the electropneumatic valves 210, 220, any water at, or close to the electropneumatic valves 210, 220 remains in liquid state, even when the ambient temperatures is, or drops below zero degrees Celsius.

The above described heating of the electropneumatic valves 210, 220 may continue for as long there is a risk of freezing/re-freezing of water, i.e., until a non-existent risk of freezing of water at the electropneumatic valves 210, 220 is detected, for example based on temperature measurements in comparison with the temperature threshold limit, above 0 degrees temperature; and/or current position of the vehicle 100; and/or no moisture/water detection inside the parking brake unit.

Thanks to the provided solution concerning the continuous-heating function, the risk of refreezing of water at the electropneumatic valves 210, 220 is eliminated, resulting in a safer vehicle in cold/freezing temperature driving.

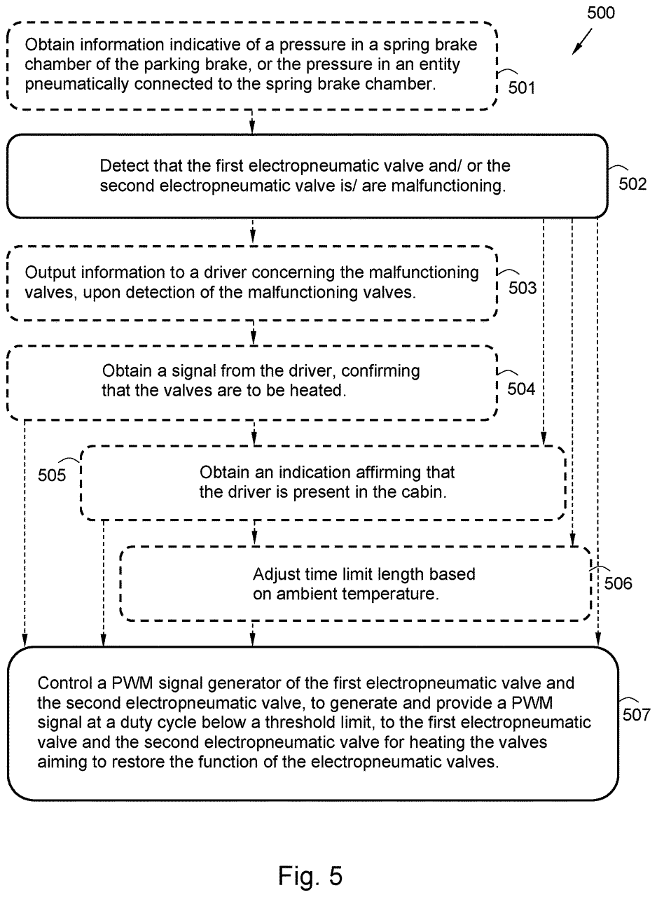

FIG. 5 illustrates an example of a method 500 according to an embodiment. The flow chart in FIG. 5 shows the method 500 for a controller 300 of a vehicle 100, which vehicle 100 comprises an electronically controlled pneumatic parking brake system 305. The purpose of the method 500 is to heat electropneumatic valves 210, 220 comprised in the electronically controlled pneumatic parking brake system 305 by providing a PWM signal. Thereby, ice formation in the valves 210, 220 is melted and/or vaporized.

In order to be able to correctly heat-up the valves 210, 220, the method 500 may comprise a number of steps 501-507. However, some of these steps 501-507 may be performed in various alternative manners. Some method steps may only be performed in some optional embodiments; such as e.g., steps 501 and/or 503-506. Further, the described steps 501-507 may be performed in a somewhat different chronological order than the numbering suggests. The method 500 may comprise the subsequent steps:

Step 501, which may be performed in some embodiments, comprises obtaining information indicative of a pressure in a spring brake chamber 320 of the parking brake 360, or the pressure in an entity pneumatically connected to the spring brake chamber 320.

The pressure in the spring brake chamber 320 may be estimated based on a pressure sensor measurement. The pressure sensor may be situated in the spring brake chamber 320, in the control chamber 260, at the brake chamber connection 275, or any similar appropriate position reflecting the pressure in the spring brake chamber 320.

Step 502 comprises detecting that the first electropneumatic valve 210 and/or the second electropneumatic valve 220 is/are malfunctioning.

The detection that the first electropneumatic valve 210 and/or the second electropneumatic valve 220 is/are malfunctioning may be made based on the obtained 501 information.

Other ways of detecting malfunctioning electropneumatic valves 210, 220 may be to detect a movement of the vehicle 100 when having set the hand control unit 310 in the active position p, possibly in combination with estimation of a temperature below 0 degrees Celsius.

In some embodiments, wherein step 502 has been performed may comprise controlling the PWM signal generator 301 to generate and provide a PWM signal at an operative duty cycle to the second electropneumatic valve 220 for heating the second electropneumatic valve 220 aiming to restore the function of the second electropneumatic valve 220. This may be referred to as a pre-heating procedure/function. The operative duty cycle may be appropriate for actuating the electropneumatic valves 210, 220.

The operative duty cycle may be about 20-40%, such as for example about 33% or at the same or similar duty cycle as during normal operation of the electropneumatic valves 210, 220.

Step 503, which may be performed in some embodiments wherein step 502 has been performed, comprises outputting information to a driver of the vehicle 100 concerning the malfunctioning valves 210, 220, upon detection 502 of the malfunctioning valves 210, 220.

The information may be output on an output device 410 in the cabin 101 of the vehicle 100, in form of text, illuminated symbol, image, movie, voice message, and/or sound in any combination. Instructions to the driver for performing the brake recovery procedure may concurrently be output.

Step 504, which may be performed in some embodiments wherein step 503 has been performed, comprises obtaining a signal from the driver, confirming that the valves 210, 220 are to be heated.

The signal of the driver may for example comprise depression of a dedicated button on the vehicle dashboard; a gentle nodding of the head (in case of a driver monitoring camera input to the controller 300); an affirmative groan (in case of cabin microphone input to the controller 300), etc.

Step 505, which may be performed in some embodiments, comprises obtaining an indication affirming that the driver is present in the cabin 101 of the vehicle 100.

The driver may be detected for example by a weight sensor in the driving seat, by a driver monitoring camera in the cabin 101, by an IR sensor in the cabin 101, by detecting driver input on the vehicle dashboard, infotainment, navigator, etc.

The indication affirming driver presence in the cabin 101 may comprise depression of the braking pedal, holding the hands on the driving wheel, or performing other similar action requiring presence of the driver in the cabin 101.

Step 506, which may be performed in some embodiments, comprises adjusting a time limit length for which the PWM signal is provided to the electropneumatic valves 210, 220, for the purpose of heating the valves 210, 220, based on ambient temperature.

The colder it is, the more heating energy is required to melt the ice formation having built up in the electropneumatic valves 210, 220. The amount of generated heat is proportional to the length of the time that the PWM signal is provided to the coil of the electropneumatic valves 210, 220. Thus, the recovery program may be allowed to run for longer time the colder it is.

Some examples may be to set the time limit length of the recovery program to one minute when the ambient temperature is about/below zero degrees; 90 seconds when the ambient temperature is about/below −5 degrees; 2 minutes when the ambient temperature is about/ below −10 degrees, etc.

The ambient temperature may be determined by an on-board temperature sensor. Alternatively, information on an ambient temperature may be obtained from a vehicle external source, for example a temperature sensor or weather service situated at the roadside or in another location, for example another close-by vehicle. Such information could be obtained by the vehicle 100 via a wireless communication interface.

The temperature may alternatively or in addition be estimated based on a combination of knowledge of geographical position of the vehicle 100, planned driving route/destination/driving direction of the vehicle 100, and knowledge of date/time and statistical data related to expected temperatures related to the date/time at the (current or future) geographical position of the vehicle 100.

In yet some embodiments, knowledge of date/time in combination with current or future geographical position of the vehicle 100 and meteorological forecast data relevant for the geographical position in combination with date/time may be relied upon.

Step 507 comprises controlling a Pulse Width Modulation (PWM) signal generator 301 of the first electropneumatic valve 210 and the second electropneumatic valve 220, to generate and provide a PWM signal at a duty cycle below a threshold limit, to the first electropneumatic valve 210 and the second electropneumatic valve 220 for heating the valves 210, 220 aiming to restore the function of the electropneumatic valves 210, 220. This may be referred to as a recovery program.

In some embodiments, wherein step 504 has been performed, the step of controlling the PWM signal generator 301 to generate and provide the PWM signal may be performed when having obtained 504 the confirmation of the valve heating from the driver.

In some embodiments, wherein step 504 has been performed, the PWM signal generator 301 may be controlled to generate and provide the PWM signal when having obtained 505 the indication affirming that the driver is present in the cabin 101.

The PWM signal generator 301 may in some embodiments be instructed to generate and provide the PWM signal at a duty cycle between about 20-40%, such as for example about 33%; or at the same duty cycle as during normal operation of the electropneumatic valves 210, 220.

The PWM signal generator 301 may in some embodiments be instructed to adapt the duty cycle of the PWM signal, based on the ambient temperature, wherein an active phase of the duty cycle is extended in lower ambient temperature and vice versa.

For example, when the ambient temperature is lower than −20 degrees, the duty cycle may be set to 40%; when the ambient temperature is about −20-−10 degrees, the duty cycle may be set to 30%; when the ambient temperature is about −10-0 degrees, the duty cycle may be set to 20%; etc.

The PWM signal generator 301 may be controlled to interrupt generating and providing the PWM signal either when detecting that the first electropneumatic valve 210 and/or the second electropneumatic valve 220 is/are functioning; or upon lapse of a predefined or configurable time limit; or when an indication is received that the driver is absent in the non-autonomous vehicle 100; or when no service brake signal is received.

In some embodiments the method 500 may comprise detecting a risk of freezing of water at the electropneumatic valves 210, 220.

The detection of the risk of freezing of water at the electropneumatic valves 210, 220 may be based on a comparison between ambient temperature and a temperature threshold limit in some embodiments. Also/alternatively, the risk of freezing of water at the electropneumatic valves 210, 220 may be detected based on geographical position of the vehicle 100 in combination with seasonal information.

Alternatively, in embodiments wherein the brake recovery function according to step 507 and/or the pre-heating according to step 502 has/have been performed, it may be concluded that there is a risk of freezing of water at the electropneumatic valves 210, 220.

The method 500 may also comprise to, when there is a risk of freezing of water, control a PWM signal generator 301 of the first electropneumatic valve 210 and the second electropneumatic valve 220, to generate and provide a PWM signal at a duty cycle to the first electropneumatic valve 210 and the second electropneumatic valve 220 for heating the valves 210, 220, wherein the duty cycle is lower than required to actuate the electropneumatic valves 210, 220. This may be referred to as continuous heating function.

The duty cycle may be set to 10-15%, i.e., a duty cycle which is too low to actuate the electropneumatic valves 210, 220.

The method 500 may also comprise, when the continuous heating function has been performed, controlling the PWM signal generator 301 of the first electropneumatic valve 210 and the second electropneumatic valve 220, to discontinue generation and provision of the PWM signal to the first electropneumatic valve 210 and the second electropneumatic valve 220 upon detection of a non-existent risk of freezing of water at the electropneumatic valves 210, 220.

Some examples of non-existence of these risks may be for example ambient temperature above 0 degrees Celsius, and/or no moisture/water detection inside the parking brake unit.

In some embodiments wherein the recovery function according to step 507 has been performed and function of the electropneumatic valves 210, 220 has been restored, the method 500 may comprise controlling the PWM signal generator 301 to alternately generate and provide the PWM signal at the same or similar operative duty cycle as during normal operation of the electropneumatic valves 210, 220 to the first electropneumatic valve 210 and the second electropneumatic valve 220, for iteratively applying and releasing the parking brake 360 by alternately opening and closing, respectively, the first electropneumatic valve 210 and the second electropneumatic valve 220. The operative duty cycle may be appropriate for actuating the electropneumatic valves 210, 220, i.e., about 20-40%, such as for example about 33%.

The PWM signal generator 301 may be controlled to iteratively apply and release the parking brake 360 for a plurality of times during the moisture removal function, for example for a limited number of times. The limited number of times may be for example 5-50 times in some embodiments. In some embodiments, the parking brake 360 may be iteratively applied and released during a time period, which may be limited; for example, a limited number of seconds, such as 20-60 seconds.

In some embodiments, the controller 300 may be operable to obtain information of an ambient temperature. The controller 300 may then be configured to adjust the limited number of times for which the PWM signal generator 301 is to iteratively apply and release the parking brake 360, based on the ambient temperature.

The limited number of times for which the PWM signal generator 301 may iteratively apply and release the parking brake 360 during the moisture removal function may be proportional to the ambient temperature. Thus, more iterations of the application/releasing of the parking brake 360 may be applied in colder temperature and fewer iterations in milder temperature.

Some examples may be to set the limited number of times to 0 when the ambient temperature exceeds zero degrees; to about 5-20 when the ambient temperature is about zero degrees; to about 10-40 when the ambient temperature is about/below −5 degrees; to about 20-50 when the ambient temperature is about/below −10 degrees; etc. (non-limiting examples).

The above described method steps 501-507 to be performed in the vehicle 100 may be implemented through the one or more controllers 300, together with a computer program product for performing at least some of the functions of the method steps 501-507. Thus, a computer program product, comprising instructions for performing the method steps 501-507 in the controller 300 may perform the method 500 for heating the electropneumatic valves 210, 220 aiming to restore the function of the electropneumatic valves 210, 220, when the computer program is loaded into the controller 300.

The computer program product mentioned above may be provided for instance in the form of a computer readable medium or data carrier carrying computer program code for performing at least some of the method steps 501-507 when being loaded into the controller 300. The computer-readable medium may be a non-transitory computer-readable medium, such as a tangible electronic, magnetic, optical, infrared, electromagnetic, and/or semiconductor system, apparatus, and/or device.

The terminology used in the description of the embodiments as illustrated in the accompanying drawings is not intended to be limiting of the described electronically controlled pneumatic parking brake system 305, method 500, computer program product, computer-readable storage medium and/or vehicle 100. Different features illustrated in different FIGS. 1-5 and/or described in different sections of the description may with certain advantage be combined with each other, in different embodiments.

Various changes, substitutions and/or alterations may be made, without departing from invention embodiments as defined by the appended claims.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g., a processor may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware but may also be distributed in other forms such as via Internet or other wired or wireless communication system.

1. An electronically controlled pneumatic parking brake system for a vehicle, wherein the system comprises:
a controller configured to generate an electronic brake apply signal when receiving an indication that a parking brake is to be onset/activated, and to generate an electronic brake release signal when receiving an indication that the parking brake is to be released/deactivated;
an air supply source, for providing compressed air;
a first electropneumatic valve, communicatively connected to the controller and connected to the air supply source and to a control chamber, wherein the first electropneumatic valve is operable to release the parking brake by opening the first electropneumatic valve, thereby allowing compressed air to flow through the first electropneumatic valve into the control chamber when receiving the electronic brake release signal from the controller; and
a second electropneumatic valve, communicatively connected to the controller and connected to the control chamber and to an exhaust port, wherein the second electropneumatic valve is operable to activate the parking brake by opening the second electropneumatic valve thereby releasing compressed air from the control chamber to atmosphere via an exhaust port when receiving the electronic brake apply signal from the controller,
wherein the controller is configured to:
detect that the first electropneumatic valve and/or the second electro-pneumatic valve is/are malfunctioning; and
control a Pulse Width Modulation (“PWM”), signal generator of the first electropneumatic valve and the second electropneumatic valve, to generate and provide a PWM signal at a duty cycle below a threshold limit, to the first electropneumatic valve and the second electropneumatic valve for heating the valves aiming to restore the function of the electropneumatic valves.

2. The system according to claim 1, wherein the controller is configured to:
output information to a driver of the vehicle concerning the malfunctioning valves, upon detection of the malfunctioning valves; and
control the PWM signal generator to generate and provide the PWM signal when having obtained a confirmation of the valve heating from the driver.

3. The system according to claim 1, wherein the controller is configured to obtain an indication affirming that a driver is present in the cabin; and control the PWM signal generator to generate and provide the PWM signal when having obtained the indication affirming that the driver is present in the cabin.

4. The system according to claim 1, wherein the threshold limit is about 50%.

5. The system according to claim 1, wherein the controller is configured to control the PWM signal generator to generate and provide the PWM signal at a duty cycle between about 20-40%.

6. The system according to claim 1, wherein the controller is operable to obtain information indicative of a pressure in a spring brake chamber of the parking brake, or the pressure in an entity pneumatically connected to the spring brake chamber, and wherein the detection of the malfunctioning first electropneumatic valve and/or the second electropneumatic valve is made based on the obtained information of said pressure.

7. The system according to claim 1, wherein the controller is configured to adapt the duty cycle based on ambient temperature of the vehicle, wherein an active phase of the duty cycle is extended in lower ambient temperature and vice versa.

8. The system according to claim 1, wherein the controller is configured to control the PWM signal generator to generate and provide the PWM signal at the same duty cycle as during normal operation.

9. The system according to claim 1, wherein the controller is configured to control the PWM signal generator to generate and provide the PWM signal until one of:
detecting that the first electropneumatic valve and/or the second electropneumatic valve is/are functioning;
until lapse of a predefined or configurable time limit;
until an indication is received that the driver is absent in the non-autonomous vehicle; or
until no service brake signal is received.

10. The system according to claim 9, wherein the controller is operable to obtain information of an ambient temperature, and wherein the controller is configured to adjust the time limit length based on the ambient temperature.

11. A method for a controller of a vehicle comprising an electronically controlled pneumatic parking brake system according to claim 1, wherein the method comprises the steps of:
detecting that the first electropneumatic valve and/or the second electropneumatic valve is/are malfunctioning; and
controlling a Pulse Width Modulation (“PWM”) signal generator of the first electropneumatic valve and the second electropneumatic valve, to generate and provide a PWM signal at a duty cycle below a threshold limit, to the first electropneumatic valve and the second electropneumatic valve for heating the valves aiming to restore the function of the electropneumatic valves.

12. The method according to claim 11, wherein the method also comprises the steps of:
outputting information to a driver of the vehicle concerning the malfunctioning valves, upon detection of the malfunctioning valves ; and
obtaining signal from the driver, confirming that the valves are to be heated,
wherein the step of controlling the PWM signal generator to generate and provide the PWM signal is performed when having obtained the confirmation of the valve heating from the driver.

13. The method according to claim 11, wherein the method also comprises the step of:
obtaining an indication affirming that the driver is present in the cabin,
wherein the step of controlling the PWM signal generator to generate and provide the PWM signal when having obtained the indication affirming that the driver is present in the cabin.

14. The method according to claim 11, wherein the step of controlling the PWM signal generator to generate and provide the PWM signal, comprises an instruction to generate and provide the PWM signal at a duty cycle between about 20-40%.

15. The method according to claim 10, comprising the step of:
obtaining information indicative of a pressure in a spring brake chamber of the parking brake, or the pressure in an entity pneumatically connected to the spring brake chamber,
wherein the step of detecting that the first electropneumatic valve and/or the second electropneumatic valve is/are malfunctioning is made based on the obtained information.

16. The method according to claim 11, wherein the step of controlling the PWM signal generator to generate and provide the PWM signal, comprises an instruction to generate and provide the PWM signal at the same duty cycle as during normal operation.

17. The method according to claim 11, wherein the step of controlling the PWM signal generator comprises an instruction to interrupt generating and providing the PWM signal either when:
detecting that the first electropneumatic valve and/or the second electropneumatic valve is/are functioning;
upon lapse of a predefined or configurable time limit; or when an indication is received that the driver is absent in the non-autonomous vehicle; or
when no service brake signal is received.

18. The method according to claim 16, comprising the step of adjusting the time limit length based on ambient temperature.

19. The method according to claim 1, wherein the step of controlling the PWM signal generator comprises an instruction to adapt the duty cycle of the PWM signal, based on the ambient temperature, wherein an active phase of the duty cycle is extended in lower ambient temperature and vice versa.

20. A computer program product stored on a non-transitory computer-readable medium, said computer program product for controlling a vehicle comprising an electronically controlled pneumatic parking brake system according to claim 1, wherein said computer program product comprising computer instructions to cause a computer to perform the following operations:
detecting that the first electropneumatic valve and/or the second electropneumatic valve is/are malfunctioning; and
controlling a Pulse Width Modulation (“PWM”) signal generator of the first electropneumatic valve and the second electropneumatic valve, to generate and provide a PWM signal at a duty cycle below a threshold limit, to the first electropneumatic valve and the second electropneumatic valve for heating the valves aiming to restore the function of the electropneumatic valves.

21. (canceled)

22. A vehicle comprising an electronically controlled pneumatic parking brake system comprising:
a controller configured to generate an electronic brake apply signal when receiving an indication that a parking brake is to be onset/activated, and to generate an electronic brake release signal when receiving an indication that the parking brake is to be released/deactivated;
an air supply source, for providing compressed air;
a first electropneumatic valve, communicatively connected to the controller and connected to the air supply source and to a control chamber, wherein the first electropneumatic valve is operable to release the parking brake by opening the first electropneumatic valve, thereby allowing compressed air to flow through the first electropneumatic valve into the control chamber when receiving the electronic brake release signal from the controller; and
a second electropneumatic valve, communicatively connected to the controller and connected to the control chamber and to an exhaust port, wherein the second electropneumatic valve is operable to activate the parking brake by opening the second electropneumatic valve thereby releasing compressed air from the control chamber to atmosphere via an exhaust port when receiving the electronic brake apply signal from the controller,
wherein the controller is configured to:
detect that the first electropneumatic valve and/or the second electro-pneumatic valve is/are malfunctioning; and
control a Pulse Width Modulation (“PWM”), signal generator of the first electropneumatic valve and the second electropneumatic valve, to generate and provide a PWM signal at a duty cycle below a threshold limit, to the first electropneumatic valve and the second electropneumatic valve for heating the valves aiming to restore the function of the electropneumatic valves.
